(19) United States
(12) Patent Application Publication
(10) Pub. No.: US 2003/0185604 A1
(43) Pub. Date: Oct. 2, 2003

(54) Fixing apparatus

(75) Inventor: Yoji Sato, Mishima-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/377,600

(22) Filed: Mar. 4, 2003

(30) Foreign Application Priority Data
Mar. 29, 2002 (JP) 2002-097553

(51) Int. Cl. G03G 15/20

(52) U.S. Cl. 399/329; 219/216

(57) ABSTRACT

A fixing apparatus comprises a fixing roller, a heating roller separated from and arranged opposite to the fixing roller, a heat transfer member held by the heating roller and the fixing roller so as to move round and transfer heat from the heating roller to the fixing roller, a pressurizing roller held in contact with the fixing roller under pressure by way of the heat transfer member so as to heat an object of fixation by means of the fixing roller and put pressure on it and a regulating device which is arranged at least at one of the opposite ends of the fixing roller and held in contact with the corresponding edge of the heat transfer member so as to regulate any lateral movement, the regulating device being formed of molding synthetic resin so as to be resilient deformed when the heat transfer member exerts displaces it.

### CROSS-REFERENCE TO RELATED APPLICATIONS

This application is based upon and claims the benefit of priority from the prior Japanese Patent Application No. 2002-097553, filed Mar. 29, 2002, the entire contents of which are incorporated herein by reference.

### BACKGROUND OF THE INVENTION

1. Field of the Invention

This invention relates to a fixing apparatus used for fixing a toner image transferred onto a sheet of printing paper provided in an electrophotographic printing machine or the like.

2. Description of the Related Art

Fixing apparatuses of the above type normally comprise a fixing roller and a pressurizing roller, held in contact with the fixing roller so as to apply pressure to it. The sheet of printing paper onto which a toner image has been transferred is then fed to the nip section defined between the fixing roller and the pressurizing roller. The toner image is fixed to the printing paper as the sheet passes through the nip section.

The fixing roller is provided in the inside thereof with a heater, which heats the fixing roller from inside.

However, such a fixing roller is accompanied by a disadvantage that it takes much time for the internal heater to heat the fixing roller until the temperature of the outer surface of the roller reaches that necessary for fixation.

Recently, there has been developed a fixing apparatus in which a heating roller is arranged at a position separated from the fixing roller so as to hold a heat transfer belt (to be referred to as fixing belt hereinafter) with the fixing roller. With such an apparatus, heat generated by the heating roller is transferred to the outer surface of the fixing roller by turning the fixing belt, so that the temperature of the outer surface of the fixing roller can be raised to the necessary level in a short period of time.

However, as the fixing belt revolves, it may be displaced toward one of the opposite axial ends of the heating roller, due to differences in length of the opposite edges of the fixing belt, the load on the opposite sides of the contact/nip section, and a non-parallel arrangement of the fixing roller and the heating roller.

Therefore, a guide body is arranged at least at one of the opposite axial ends of the heating roller, in order to limit the lateral movement of the fixing belt.

However, as the fixing belt is urged to move aside by a particularly large force (e.g., during warm-up of the fixing apparatus when the diameter of the heating roller becomes variable and unstable due to thermal expansion), a large reactive force, as large as the force that urges the fixing belt to move aside, is exerted on the fixing belt by the guide body, which consequently buckles and damages the fixing belt along the edges.

Conventionally, an urging member, such as a coil spring, is provided in such a way that the guide body is compelled to retreat against the urging force of the urging member when a particularly large force is applied to the fixing belt to move it aside so that a large reactive force may not be exerted to the fixing belt.

However, such a conventional arrangement requires the use of urging members including a coil spring in addition to a guide body to increase the number of parts and raise the cost. Furthermore, the assembly operation is cumbersome and time consuming.

### BRIEF SUMMARY OF THE INVENTION

In view of the above identified circumstances, it is therefore the object of the present invention to provide a fixing apparatus that is adapted to retreat the regulating (guide) member without requiring the use of urging members if the heat transfer member is displaced by a large force.

According to an aspect of the invention, the above object is achieved by providing a fixing apparatus comprising a fixing roller, a heating roller separated from and arranged opposite to the fixing roller, a heat transfer member held by the heating roller and the fixing roller, so as to revolve around them and transfer heat from the heating roller to the fixing roller, a pressurizing roller held in contact with the fixing roller under pressure by way of the heat transfer member so as to heat an object of fixation by means of the fixing roller and put pressure on it, and a regulating device which is arranged at least at one of the opposite ends of the fixing roller and is held in contact with the corresponding edge of the heat transfer member so as to regulate any lateral movement, the regulating device being formed of molded synthetic resin so as to be resiliently deformed when the heat transfer member exerts a force on it.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a schematic cross sectional view of an embodiment of a fixing apparatus according to the invention;

FIG. 2 is a schematic front view of fixing the apparatus of FIG. 1;

FIG. 3 is a schematic illustration of elastic deformation of the elastic guide section of the guide member of the fixing apparatus of FIG. 2; and

FIG. 4 is a schematic perspective view of the guide member of FIG. 3.

### DETAILED DESCRIPTION OF THE INVENTION

The present invention will now be described, referring to the accompanying drawings that illustrate a preferred embodiment.

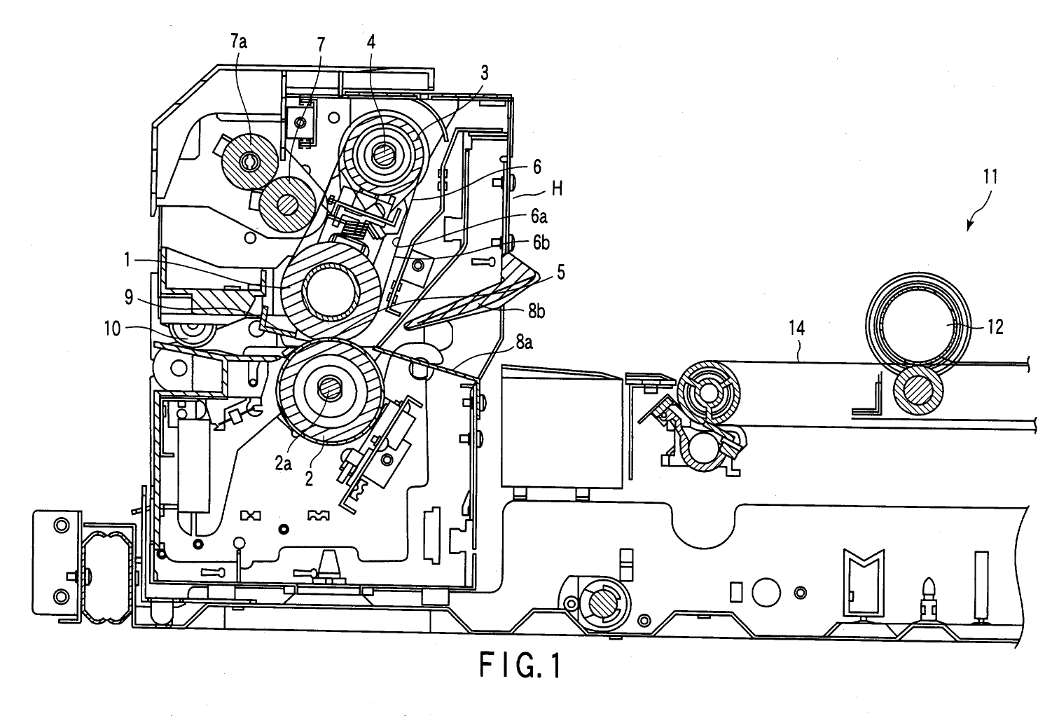

FIG. 1 is a schematic cross sectional view of an embodiment of a fixing apparatus according to the invention, illustrating its configuration.

The fixing apparatus can typically be used in an electrophotographic copying machine. It comprises a main body frame H and a fixing roller 1 which is an elastic roller arranged in the main body frame H. A pressurizing roller 2 is arranged under the fixing roller 1. The pressurizing roller 2 is also an elastic roller, but has a hardness higher than that of the fixing roller 1. It contains a heater 2a in the inside, which may be a halogen lamp.

A heating roller 3 is arranged above the fixing roller 1. The heating roller 3 also contains a heater 4 in the inside, which may be a halogen lamp. The fixing roller 1, the pressurizing roller 2 and the heating roller 3 are rotatably supported by respective rotary shafts that extend in parallel with each other between the two side frame members of the main body frame H. A fixing belt 6 is wound around and held by the fixing roller 1 and the heating roller 3. It operates as a heat transfer device. The fixing belt 6 has a belt base member 6a and a heat-resistant elastic releasing layer 6b coated on the outer surface of the belt base member 6a.

The distance between the rotary shaft of the fixing roller 1 and that of the pressurizing roller 2 is slightly less than the sum of the radii of the fixing roller 1 and that of the pressurizing roller 2. Therefore, the fixing roller 1 and the pressurizing roller 2 press against each other to produce a nip section 5, and the fixing roller 1 is slightly depressed by the pressurizing roller 2.

An oil applicator roller 7 is held in contact with the fixing belt 6. The oil applicator roller 7 is pressed against the fixing belt 6 and is adapted to apply silicon oil to and, at the same time, clean the outer surface of the fixing belt 6. The oil applicator roller 7 is pressed against the fixing belt 6 so that the latter is subject to a predetermined level of tension. A cleaner 7a is rotatably held in contact with the oil applicator roller 7.

Guide bodies 8a and 8b are arranged in the nip section 5 defined by the fixing roller 1 and the pressurizing roller 2 at the sheet of paper receiving side thereof. They are adapted to guide a sheet of paper P, i.e., or an object of fixation. A releasing member is arranged at the sheet of paper delivery side of the fixing roller 1 in order to release the sheet of paper P adhering to the fixing belt 6. A discharging roller 10 is arranged at the downstream side of the nip section 5, to discharge the sheet of paper P from the main body frame H.

On the other hand, an image forming section 11 is arranged at the upstream side of the fixing apparatus for delivering the sheet of paper P. The image forming section 11 includes a plurality of photosensitive drums 12 (only one of which is shown) arranged in series for delivering the sheet of paper P. Toner images of cyan, magenta, yellow and black are formed on the photosensitive drums 12. The toner images of different colors formed on the respective photosensitive drums 12 are transferred onto the sheet of paper P to produce a color image.

The sheet of paper P onto which the toner images are transferred is then conveyed toward the fixing device by conveyor belt 14 so that it eventually enters and passes through the nip section 5 between fixing roller 1 and the pressurizing roller 2, guided by the guide bodies 8a, 8b. As the sheet of paper P passes through the nip section 5, it is heated and pressurized to fix the transferred toner images, i.e., the color toner image. After the fixing process, the sheet of paper P is delivered to the outside by the discharging roller 10.

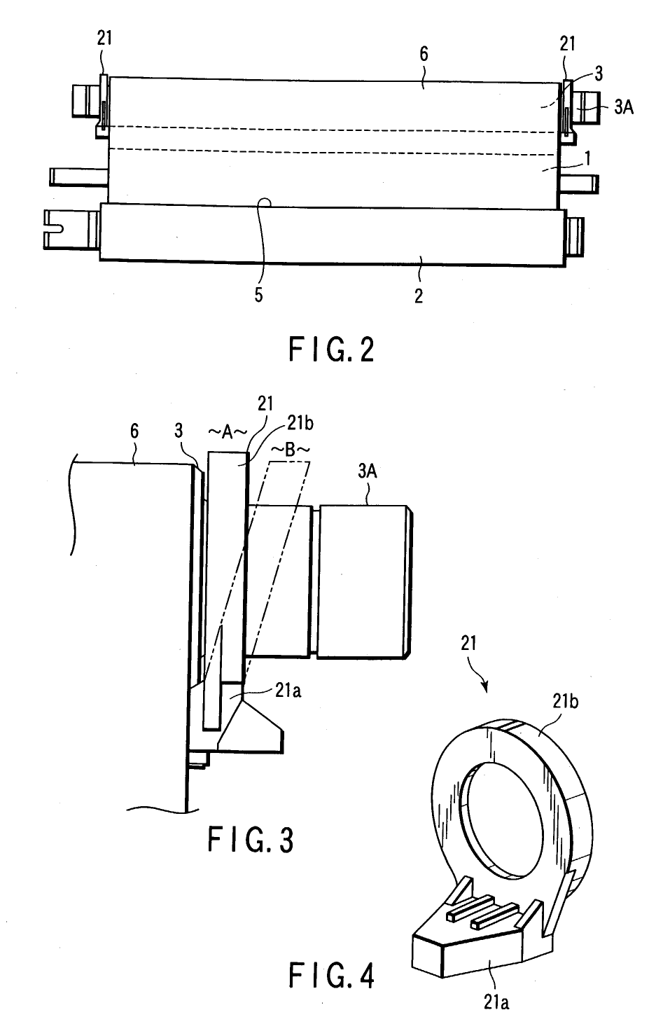

As also shown in FIG. 2, the fixing belt 6 is held by and wound around the fixing roller 1 and the heating roller 3. However, as the fixing belt 6 revolves, it may be displaced toward one of the opposite axial ends of the heating roller 3, due to differences in length of the opposite lateral edges of the fixing belt, the load on the opposite sides of the contact/nip section 5, and non-parallel arrangement of the fixing roller 1 and the heating roller 3.

According to the invention, any such lateral movement of the fixing belt 6 is regulated by regulating means, i.e., a pair of guide members 21, arranged at the respective opposite ends of the shaft 3A of the heating roller 3.

FIG. 3 is an enlarged schematic view of one of the guide members 21 fitted to the shaft 3A of the heating roller 3 and FIG. 4 is a schematic perspective view of the guide member 21.

The guide members 21 are formed of molding synthetic resin so as to be elastically and resiliently deformed to provide a force damping effect. More specifically, the guide members 21 are made of a synthetic resin material that is softer than the material of the belt base member 6a of the fixing belt 6 and more elastic than metals such as aluminum.

Each of the guide members 21 includes a base section 21a and an annular elastic guide section 21b integrally formed with the base section 21a. The elastic guide sections 21b have an inner diameter greater than the outer diameter of the shaft 3A of the heating roller 3. The shaft 3A of the heating roller 3 is driven through the elastic guide sections 21b. The base sections 21a of the guide members 21 are rigidly held by respective side frames of the fixing apparatus by means of respective holding means (not shown).

The elastic guide section 21b of each of the guide members 21 can be elastically and resiliently deformed around the link section that links the base section 21a and the elastic guide section 21b so as to be displaced from a first position A to a second position B and vice versa. More specifically, in the normal operating condition, the elastic guide section 21b shown in FIG. 3 is in the first position A as indicated by solid lines, where it stands upright. As the fixing belt 6 is moved aside toward it, it is elastically and resiliently deformed and becomes inclined and displaced to take the second position B.

Now, the operation of the guide member 21 guiding the fixing belt 6 will be described.

As the fixing belt 6 is revolving and a force is generated which displaces the fixing belt 6, the fixing belt 6 is displaced toward either of the opposite axial ends of the heating roller 3. If the force displacing the fixing belt 6 is smaller than a predetermined level, the elastic guide section 21b of the corresponding guide member 21 remains in the first position A, where it stands upright and guides the corresponding edge of the fixing belt 6. In other words, the elastic guide section 21b regulates the lateral movement of the fixing belt 6.

However, a force displacing the fixing belt 6 can be maximal in the warming up phase of operation of the fixing apparatus when the diameter of the heating roller 3 is unstable, due to thermal expansion. Therefore, one of the lateral edges of the fixing belt 6 strongly rubs against the elastic guide section 21b of the corresponding guide member 21. If so, the elastic guide member 21b is resiliently deformed and becomes inclined. Thus, it is displaced from the first position A to the second position B. Therefore, the reactive force exerted on the lateral edge of the fixing belt 6 by the elastic guide member 21b is reduced and the edge of the fixing belt 6 is reliably prevented from being buckled and damaged.

When a predetermined period of time has elapsed since the displacement of the elastic guide section 21b to the second position B, the diameter of the heating roller 3 is stabilized. Then, the force displacing the fixing belt 6 is reduced. As a result, the elastic guide section 21b returns to the fist position A from the second position B, and stands upright.

As described above, with this embodiment, when the fixing belt 6 is displaced and rubs against the elastic guide member 21b of one of the guide members 21 with a force greater than a predetermined level, the elastic guide member 21b is resiliently deformed and displaced from the first position A to the second position B so that the fixing belt 6 is not subjected to any large reactive force at the lateral edges thereof. Therefore, the lateral edges of the fixing belt 6 are prevented from being buckled and damaged.

Since the guide members 21 are formed of molding synthetic resin, they are not damaged by displacement of the fixing belt 6 rubbing against the elastic guide members 21b.

Furthermore, since the guide members 21 are made of a synthetic resin material that is softer than the material of the belt base member 6a of the fixing belt 6, more elastic than a metal such as aluminum, and the guide members 21 very smooth, the guide members 21 are highly resistant to damage caused by displacement of the fixing belt 6.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A fixing apparatus comprising:
a fixing roller;
a heating roller separated from and arranged opposite to the fixing roller;
a heat transfer member held by the heating roller and the fixing roller so as to revolve and transfer heat from the heating roller to the fixing roller;
a pressurizing roller held in contact with the fixing roller under pressure by way of the heat transfer member so as to heat an object of fixation by means of the fixing roller and put pressure on it; and
a regulating device which is arranged on at least one of the opposite ends of the fixing roller and is held in contact with the corresponding edge of the heat transfer member so as to regulate any lateral movement of the heat transfer member, the regulating device being formed of molded synthetic resin so as to be resiliently deformed when the heat transfer member exerts a force on it.

2. The apparatus according to claim 1, wherein the regulating device regulates a lateral movement of the heat transfer member at a first position when the force displacing the heat transfer member is smaller than a predetermined level and becomes resiliently deformed and displaced to a second position different from the first position when the force displacing the heat transfer member exceeds the predetermined level.

3. The apparatus according to claim 1 or 2, wherein the elastic guide member is made of a material that is softer than the material of the heat transfer member and more elastic than aluminum.

4. The apparatus according to claim 1, wherein the heating roller is provided in the inside thereof with a heat source.

5. The apparatus according to claim 1, wherein the heat transfer member has a belt base member and a heat-resistant elastic releasing layer coated on the outer surface of the belt base member.
